(19) United States
(12) Patent Application Publication
(10) Pub. No.: US 2026/0227525 A1
(43) Pub. Date: Aug. 6, 2026

(54) METHOD OF CALCULATING POSITIONING ENVIRONMENT CONTEXT INDEX

(71) Applicant: PPSoln, Inc., Seoul (KR)

(72) Inventors: Bong Gyu PARK, Chungju-si (KR); Mi So KIM, Anyang-si (KR); Kwan Dong PARK, Seoul (KR)

(21) Appl. No.: 19/293,047

(22) Filed: Aug. 7, 2025

(30) Foreign Application Priority Data
Feb. 4, 2025 (KR) 10-2025-0013637

(51) Int. Cl. G01S 19/37; G01S 19/25; G01S 19/29

(52) U.S. Cl. CPC G01S 19/37; G01S 19/258; G01S 19/29

(57) ABSTRACT

Provided is a method of calculating a positioning environment context index for classifying observation environments to help a user device global navigation satellite system (GNSS) in providing accurate location information. The method includes classifying and defining various observation environments by index, receiving observation values including at least the number of visible satellites, position dilution of precision (PDOP), and a carrier-to-noise density ratio (C/N0) with respect to a target observation environment, performing an exception handling process based on the number of visible satellites, selecting a process among a raw index calculation process and a calibrated index calculation process based on presence or absence of the PDOP, and deriving the index corresponding to the target observation environment based on the C/N0 or the C/N0 and PDOP via the selected process.

### CROSS-REFERENCE TO RELATED APPLICATION

This application claims priority under 35 U.S.C. § 119 to Korean Patent Application No. 10-2025-0013637, filed on Feb. 4, 2025 in the Korean Intellectual Property Office, the disclosure of which is incorporated by reference herein in its entirety.

### BACKGROUND

### 1. Field

The present disclosure relates to a method of calculating a positioning environment context index for classifying observation environments to help a user device's global navigation satellite system (GNSS) in providing accurate location information.

### 2. Description of the Related Art

Due to the high demand for location-based services, active research has been conducted into a global navigation satellite system (GNSS) applied to user devices, such as smartphones. In order for GNSS researchers or location-based service providers to provide high-quality location information to smartphone users, high coordinate accuracy needs to be guaranteed. However, accurate positioning is difficult because of inherent limitations, such as the performance of GNSS chipsets used in smartphones and the characteristics of antennas. In particular, compared to geodetic GNSS receivers, GNSS receivers applied to smartphones have relatively high positioning errors because of poor observation value quality. Moreover, in urban areas where tall buildings are densely packed, observation errors become extreme. Various technologies are being developed to solve these problems.

To improve the positioning accuracy of a smartphone GNSS, various technologies, such as precise positioning algorithms and anomalous observation value detection, are being attempted. In addition to these technologies, technologies are also being developed to classify observation environments based on smartphone observation values. The ultimate goal of this observation environment classification technique is to apply techniques for improving positioning accuracy differently according to observation environments. Therefore, research into accurately classifying observation environments is required.

### SUMMARY

The present disclosure aims to provide a highly reliable positioning environment context index for the purpose of accurately classifying observation environments in order to improve the accuracy of position information provided by a smartphone global navigation satellite system (GNSS).

An aspect of the present disclosure discloses a method of calculating a positioning environment context index for classifying an observation environment. The method includes classifying and defining various observation environments by index, receiving observation values including at least the number of visible satellites, position dilution of precision (PDOP), and a carrier-to-noise density ratio (C/N0) with respect to a target observation environment, performing an exception handling process based on the number of visible satellites, selecting a process among a raw index calculation process and a calibrated index calculation process based on presence or absence of the PDOP, and deriving the index corresponding to the target observation environment based on the C/N0 or the C/N0 and PDOP via the selected process, wherein the method is performed by a processor.

Here, the raw index calculation process may include obtaining a real number-type raw index based on the C/N0, inputting the real number-type raw index into a classification model, and deriving an integer-type raw index as the index.

Here, the calibrated index calculation process may include obtaining the real number-type raw index based on the C/N0, obtaining a real number-type calibrated index considering the real number-type raw index and the PDOP, and deriving an integer-type calibrated index from the real number-type calibrated index as the index, or deriving an integer-type raw index from the real number-type calibrated index as the index.

Here, the various observation environments may be classified into and defined as open outdoors, a semi-urban area, a central urban area, a semi-indoor area, and an indoor area.

Here, the exception handling process may include determining whether the number of visible satellites meets a positioning requirement.

Here, the process selection may include selecting the raw index calculation process for the first positioning environment context index calculation and selecting the calibrated index calculation process when the PDOP is present in both a previous epoch and a current epoch for second and subsequent positioning environment context index calculations.

Here, the processor may be configured to derive the real number-type raw index, I_{C/N0}, based on a model,

$${I}_{C / N 0} ( t ) = \frac{1}{N} {\sum }_{i = 1}^{N} ( C / N {0}_{i} ( t ) - {μ}_{ref} ) / {σ}_{ref} ,$$

which is an average of values each obtained by subtracting a reference average, μ_{ref}, from a C/N0 of each of N satellites, which is acquired in an arbitrary epoch “t” in the target observation environment, and dividing a result of the subtraction by a standard deviation, σ_{ref}, with respect to the N satellites.

Here, the classification model may designate, as a decision boundary, an intersection between normal distributions respectively for adjacent indices in a normal distribution of a probability density for each of real number-type raw indices obtained based on multiple C/N0s acquired with respect to various arbitrary observation environments for each index, and the processor may be configured to derive the integer-type raw index from the real number-type raw index based on the classification model.

Here, the processor may be configured to obtain the real number-type calibrated index through a model, I=α(W_{PDOP} ln PDOP+W_{C/N0}I_{C/N0}), where a is a scale factor, W_{PDOP} is a weight for the PDOP, and W_{C/N0} is a weight for the real number-type raw index.

Here, the calibrated index calculation process may include, when a variation of the PDOP exceeds a threshold, obtaining the integer-type calibrated index by inputting the real number-type calibrated index obtained by the processor into a calibrated classification model, or when the variation of the PDOP is less than or equal to the threshold, obtaining the integer-type raw index by inputting the real number-type calibrated index obtained by the processor into the classification model.

Here, the calibrated classification model may include a calibrated decision boundary considering the variation of the PDOP with respect to a decision boundary of the classification model, and the processor may be configured to input the real number-type calibrated index into the calibrated classification model and obtain the integer-type calibrated index according to the calibrated decision boundary.

Here, the method may further include calculating a likelihood ratio representing uncertainty of the positioning environment context index.

The likelihood ratio may be obtained by expressing, as a percentage, the sum of the corresponding probability density of a real number-type raw index or a real number-type calibrated index corresponding to a positioning environment context index of the target observation environment and the probability densities of real number-type raw indices corresponding to various arbitrary observation environments.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a schematic block diagram illustrating a positioning environment context index calculation system according to an embodiment;

FIG. 2 is a schematic block diagram illustrating a positioning environment context index calculation device in FIG. 1;

FIG. 3 is a flowchart of a method of calculating a positioning environment context index, according to an embodiment;

FIG. 4 is a table showing a category, a main feature, and an example photo of an observation environment for each predefined index;

FIG. 5 is a detailed flowchart of the method of FIG. 3;

FIG. 6 is a graph showing the normal probability density of real number-type raw indices with respect to five observation environments in FIG. 4;

FIG. 7 shows a sigmoid function, which is a principle used to derive a real number-type calibrated index, and an example diagram illustrating a method of calculating a weight included in the real number-type calibrated index;

FIG. 8 shows graphs illustrating a method of determining a threshold for a position dilution of precision (PDOP) variation;

FIG. 9 is an explanatory diagram illustrating a method of obtaining a calibrated decision boundary in a calibrated classification model;

FIG. 10 is an explanatory diagram illustrating calculation of a likelihood ratio, according to an embodiment; and

FIG. 11 is a graph showing results of performing, by a positioning environment context index calculation device, a method of calculating a positioning environment context index, according to an embodiment.

### DETAILED DESCRIPTION

With respect to the terms used to describe the various embodiments, general terms which are currently and widely used are selected in consideration of functions of structural components in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

Unless otherwise defined, terms used herein have the same meaning as commonly understood by one of ordinary skill in the art to which the present disclosure belongs. It will be understood that terms, such as those defined in commonly used dictionaries, should be interpreted as having a meaning that is consistent with their meaning in the context of the relevant art, and will not be interpreted in an idealized or overly formal sense unless expressly so defined herein.

As embodiments allow for various changes and numerous embodiments, some embodiments will be illustrated in the drawings and described in detail in the written description. However, this is not intended to limit embodiments to particular modes of practice, and it is to be appreciated that all changes and substitutes that do not depart from the spirit and technical scope of the present disclosure are encompassed in embodiments. The terms used herein are used only to describe embodiments and are not intended to limit the embodiments.

The detailed descriptions of the present invention below refer to the accompanying drawings which illustrate specific embodiments in which the present invention may be implemented. These embodiments are described in sufficient detail to enable those skilled in the art to implement the present invention. It should be understood that the various embodiments of the present invention are different from each other but are not necessarily mutually exclusive. For example, specific shapes, structures, and characteristics described herein may be implemented as modified from one embodiment to another without departing from the spirit and scope of the present invention. Furthermore, it should be understood that the locations or arrangements of individual components within each of the embodiments may also be changed without departing from the spirit and scope of the present invention. Therefore, the detailed descriptions set forth below are not be taken in a limiting sense, and the scope of the present invention is to be taken as encompassing the scope of the appended claims and all equivalents thereof. In the drawings, like reference numerals denote identical or similar components throughout several views.

While terms including ordinal numbers such as “first,” “second,” etc., may be used to describe various components, such components must not be limited to the above terms. The above terms are used only to distinguish one component from another.

It should be understood that when a component is referred to as being “connected” or “coupled” to another component, it can be directly connected or coupled to the other component or there may be other components therebetween. In contrast, when a component is referred to as being “directly connected” or “directly coupled” to another component, it should be understood that there are no other components therebetween.

Hereinafter, various embodiments of the present invention will be described in detail with reference to the accompanying drawings so as to be easily implemented by one of ordinary skill in the art to which the present invention belongs.

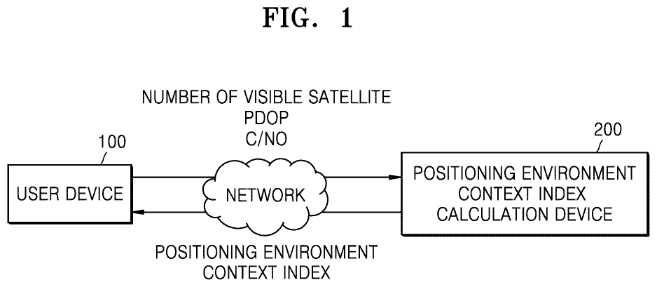

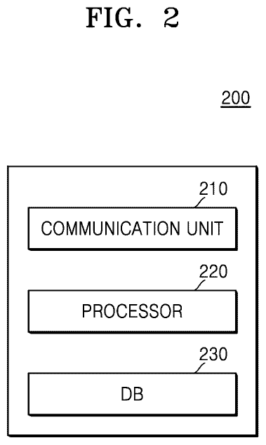

FIG. 1 is a schematic block diagram illustrating a positioning environment context index calculation system according to an embodiment. FIG. 2 is a schematic block diagram illustrating a positioning environment context index calculation device in FIG. 1.

Referring to FIG. 1, a positioning environment context index calculation system may include a user device 100 and a positioning environment context index calculation device 200 connected to the user device 100 via a network. Here, positioning refers to determining a user's location through a system such as a global navigation satellite system (GNSS). A positioning environment context index or an index refers to a type of index for classifying an observation environment. An observation environment refers to a site in which the user device 100 receives an observation value.

Any device capable of implementing a GNSS function may be applied as the user device 100. The user device 100 may include at least one selected from the group consisting of portable communication devices including a smartphone, computer devices, portable multimedia devices, cameras, vehicle navigation devices, various wearable devices including smartwatches, and home appliances. A case where the user device 100 is a smartphone is described as an example below.

The user device 100 may include at least an antenna and a GNSS chipset for implementing GNSS functions. The user device 100 may collect observation values, which include at least the number of visible satellites, position dilution of precision (PDOP), and a carrier-to-noise density ratio (C/N0), through a GNSS and may transmit the observation values to the positioning environment context index calculation device 200.

The positioning environment context index calculation device 200 may receive observation values from the user device 100 and may calculate a positioning environment context index. The calculated positioning environment context index may be transmitted to the user device 100 or transmitted to the outside of the positioning environment context index calculation system. The positioning environment context index calculation device 200 may be implemented as a separate device from the user device 100. However, without being limited thereto, the positioning environment context index calculation device 200 may be embedded in a user device as a processor, may be implemented in a recording medium as an application or a program, or may be implemented as a server. The implementation form of the positioning environment context index calculation device 200 is not limited to what has been mentioned and may be replaced in various ways.

Referring to FIG. 2, the positioning environment context index calculation device 200 may include a communication unit 210, a processor 220, and a database (DB) 230. Although only components related to the embodiment are illustrated in FIG. 2, the positioning environment context index calculation device 200 may further include other general-purpose components than the illustrated components.

The communication unit 210 may include one or more components that communicate with a user device via a network. For example, the communication unit 210 may include at least one of a short-range communication unit, a mobile communication unit, and a broadcast receiving unit.

The DB 230 may include a hardware component that stores various data processed in the positioning environment context index calculation device 200 and may also store a program for processing and controlling the processor 220 in addition to the various data. The DB 230 may include random access memory (RAM) such as dynamic RAM (DRAM) or static RAM (SRAM), read-only memory (ROM), electrically erasable programmable ROM (EEPROM), compact disc (CD)-ROM, Blu-ray or other optical disk storage, hard disk drive (HDD), solid state drive (SSD), or flash memory.

The processor 220 may generally control operations of the positioning environment context index calculation device 200. For example, the processor 220 may generally control the communication unit 210 and the DB 230 by executing programs stored in the DB 230. The processor 220 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The network may enable data transfer between the user device 100 and the positioning environment context index calculation device 200. For example, the network may be implemented as a long-distance communications network, such as a cellular network, the Internet, or a computer network (e.g., a local area network (LAN) or a wide area network (WAN)).

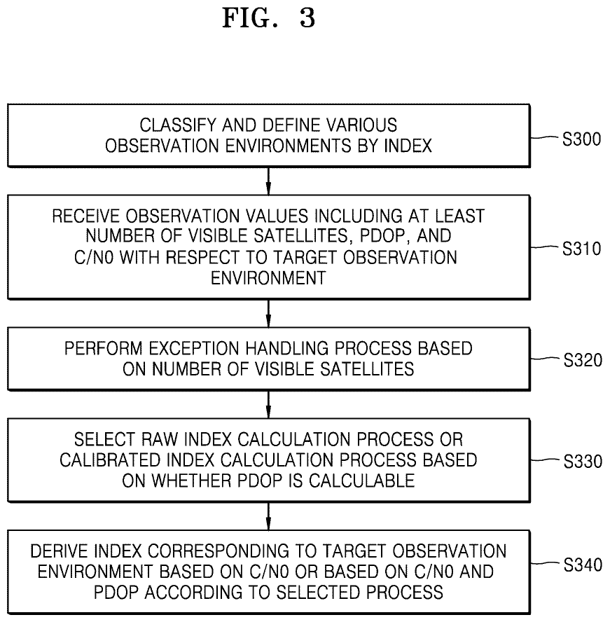

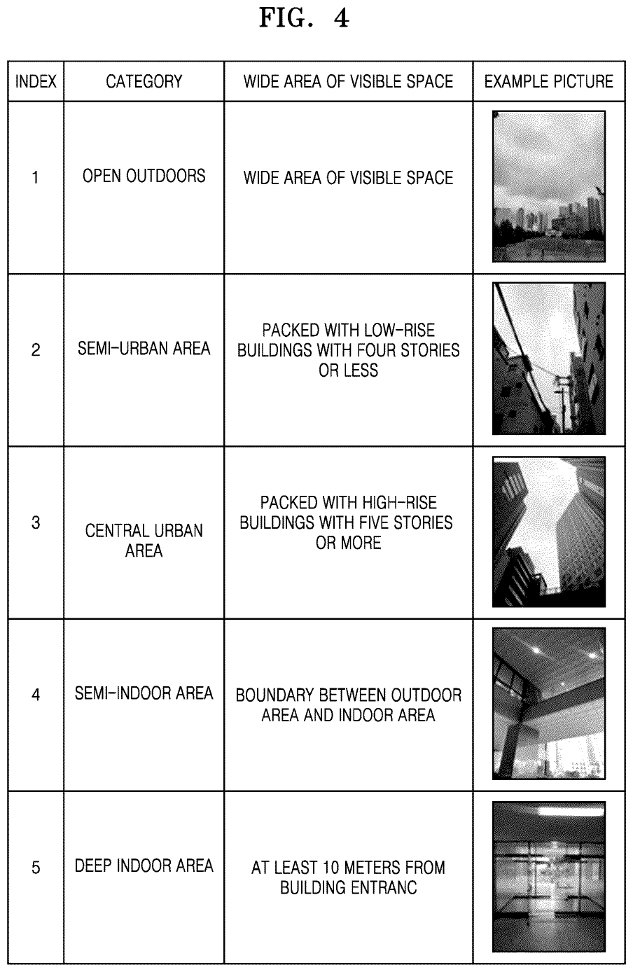

FIG. 3 is a flowchart of a method of calculating a positioning environment context index, according to an embodiment. FIG. 4 is a table showing a category, a main feature, and an example photo of an observation environment for each predefined index.

Referring to FIG. 3, the positioning environment context index calculation device 200 (hereinafter referred to as a device) may classify and define a plurality of different observation environments by index in operation S300. Observation environments may be classified according to the ease of signal acquisition from visible satellites and the density of obstacles such as buildings and may be defined by index. The device may classify different observation environments into a certain number of categories and may set an index for each category.

Referring to FIG. 4, the device may classify the observation environments into five categories and set an index of 1 to 5 for each category. However, this is just an example, and the device may classify the observation environments into a smaller number of categories or a larger number of categories.

As illustrated in FIG. 4, the device may classify an observation environment, in which it is advantageous to secure signals from visible satellites or in which the density of obstacles is low, as a small numerical index and may classify an opposite case as a high numerical index. For example, observation environments may be classified into at least five categories: open outdoors, a semi-urban area, a central urban area, a semi-indoor area, and a deep indoor area.

The open outdoors may be defined as an environment, which has the lowest density of obstacles and is advantageous for securing visible satellites, and may include, for example, a sports field, a flat area in a suburban area, a wide open space, a field, a park, or the like. In an embodiment, the open outdoors may be classified as an index “1”.

The semi-urban area may be defined as an environment, which has a moderate density of low-rise buildings and in which signal reception is more limited than in the open outdoors and is better than in the central urban area, and may include, for example, an alleyway between buildings with four stories or less, a residential area with many low-rise buildings, a villa complex, a small commercial district, or the like. In an embodiment, the semi-urban area may be classified as an index “2”.

The central urban area may be defined as an environment, which has a high concentration of tall buildings and in which a signal is severely blocked or reflected, and may include, for example, a large industrial complex having buildings with five stories or more, a high-rise apartment complex, a densely populated area of high-rise buildings in a large city, or the like. In an embodiment, the central urban area may be classified as an index “3”.

The semi-indoor area may be defined as a space, which is the boundary between an indoor area and an outdoor area and is the outside but has a closed ceiling or in which a signal is partially blocked, and may include, for example, a multipurpose apartment complex, a tunnel, an entrance to an underground parking lot, or the like. In an embodiment, the semi-indoor area may be classified as an index “4”.

The deep indoor area may be defined as a space, in which a satellite signal is almost or completely blocked and thus signal acquisition is impossible, and may include, for example, a place at least about 10 meters from a building entrance, a long tunnel, a basement, or the like. In an embodiment, the deep indoor area may be classified as an index “5”.

The classified result in operation 300 may be stored in the DB 230 of the device.

Subsequently, the device may receive an observation value from the user device 100 in operation S310. The observation value refers to data that the user device 100 may acquire through a GNSS in a target observation environment. Here, the target observation environment refers to a location that a user wants to know which of the indices classified in operation 300 corresponds to. The observation value may include, but not limited to, at least the number of visible satellites, PDOP, and C/N0. Here, the number of visible satellites may be the number of satellites from which the user device 100 may receive a satellite signal in the target observation environment. The PDOP may be a numerical value that indicates whether a satellite's placement in the target observation environment is good or bad for positioning. The C/N0 may be an indicator that represents a ratio of the strength (carrier) of a satellite signal received in the target observation environment to noise density (noise). The observation value received by the device may be stored in the DB 230 of the device.

Subsequently, the device may perform an exception handling process based on the number of visible satellites in operation S320. The exception handling process may be a step of checking a minimum requirement for positioning. Here, a positioning requirement refers to determining whether the number of visible satellites meets a certain number. In the exception handling process, the device may check whether the number of visible satellites meets the requirement, and if not, may handle an exception for the rest of the process.

When the number of visible satellites meets the requirement in operation S320, the device may perform process selection (operation S330) of selecting one of a raw index calculation process (S340a) or a calibrated index calculation process (S340b), based on presence or absence of the PDOP in operation S330. Here, the presence of the PDOP may mean that the PDOP may be calculated in the target observation environment. The absence of PDOP may mean that a satellite is not sufficiently observed to perform positioning in the target observation environment or that it is difficult to acquire a signal for positioning, making it impossible to calculate the PDOP.

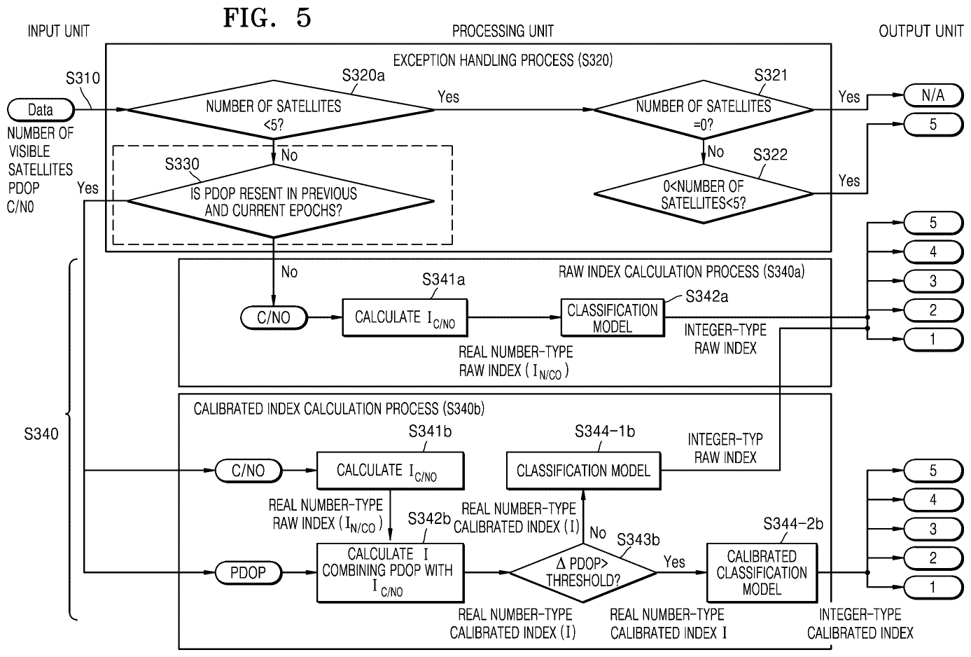

The device may calculate a positioning environment context index corresponding to the target observation environment according to the selected process in operation S340. The device may derive which index among the indices defined for the observation environments pre-classified in operation S300 corresponds to the target observation environment, based on information including only the C/N0 or information including the C/N0 and the PDOP. The device may provide the positioning environment context index derived in operation S340 to the user device 100. The calculation of the positioning environment context index is described in detail with reference to FIG. 5 below.

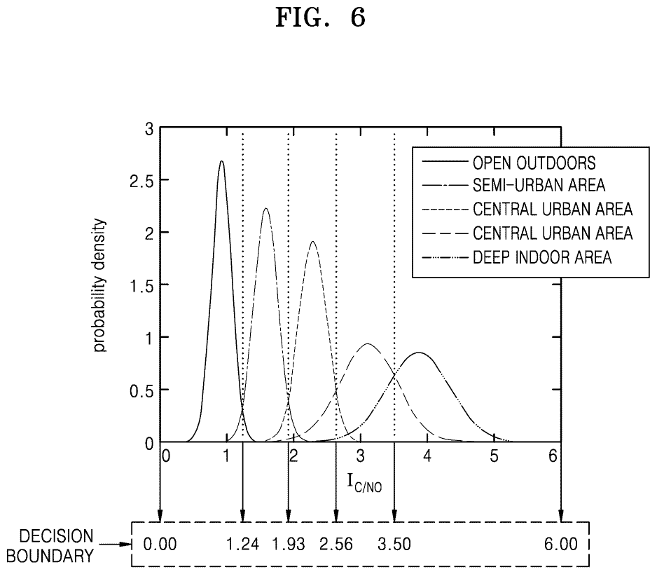

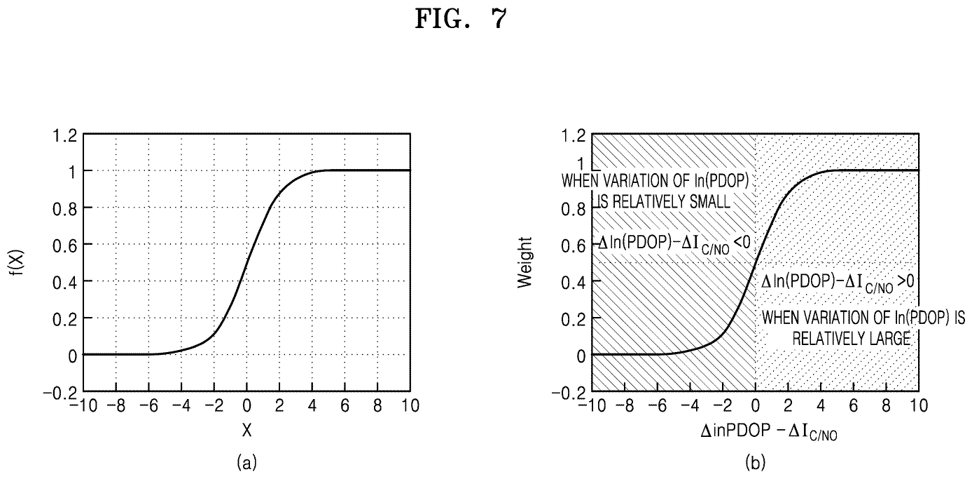

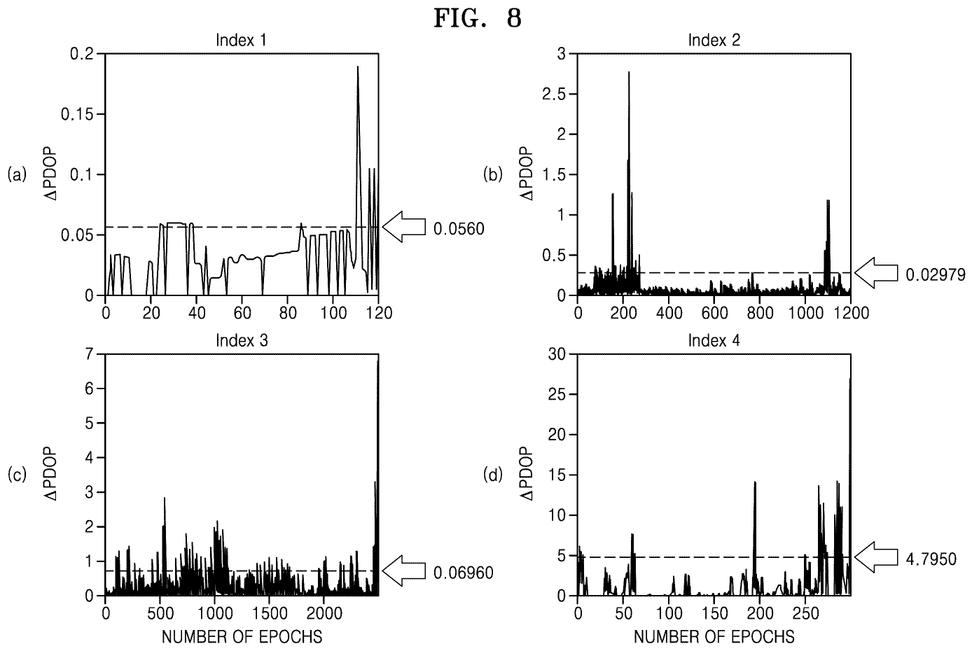

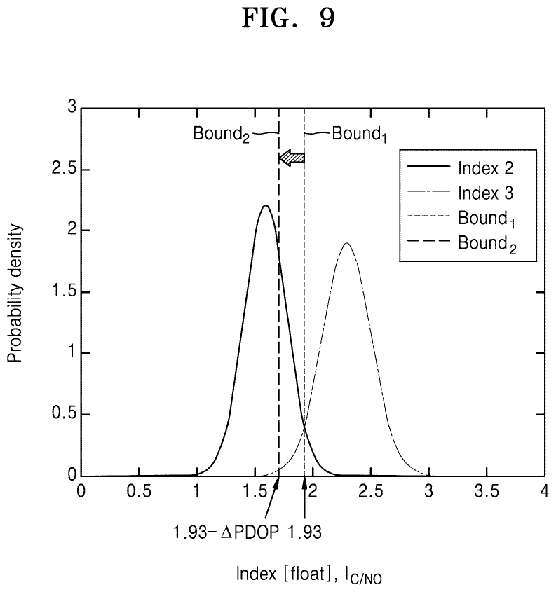

FIG. 5 is a detailed flowchart of the method of FIG. 3. FIG. 6 is a graph showing the normal probability density of real number-type raw indices with respect to five observation environments in FIG. 4. FIG. 7 shows a sigmoid function, which is a principle used to derive a real number-type calibrated index, and an example diagram illustrating a method of calculating a weight included in the real number-type calibrated index. FIG. 8 shows graphs illustrating a method of determining a threshold for a PDOP variation. FIG. 9 is an explanatory diagram illustrating a method of obtaining a calibrated decision boundary in a calibrated classification model. A method of calculating a positioning environment context index according to an embodiment is described below with reference to FIGS. 6 to 9 in addition to FIG. 5.

The processor 220 of the positioning environment context index calculation device 200 may functionally include an input unit, a processing unit, and an output unit. The input unit may receive observation values including at least the number of visible satellites, PDOP, and C/N0 in a target observation environment, on which positioning is to be performed, from the user device 100, the processing unit may calculate a positioning environment context index based on the observation values, and the output unit may output the calculated positioning environment context index to the user device 100.

The processor 220 may classify and predefine a plurality of different observation environments by index, as described in operation S300 in FIG. 3, and redundant descriptions thereof are omitted.

The processor 220 may receive observation values including at least the number of visible satellites, PDOP and C/N0 in the target observation environment from the user device 100, as described in operation S310 in FIG. 3, and redundant descriptions thereof are omitted.

Referring to FIG. 5, the processor 220 may determine whether the number of visible satellites is less than 5 in operation S320a.

When there are no visible satellites, the processor 220 may output the positioning environment context index as “not available (N/A)” in operation S321.

When there are visible satellites but less than 5, the processor 220 may output the positioning environment context index as 5 corresponding to the deep indoor area in operation S322.

In general, position determination may be made with at least four satellites for standalone positioning, but at least five satellites are required for relative positioning. Therefore, according to an embodiment, the device may adopt a minimum of five satellites as a positioning requirement in order to cope with various positioning techniques.

When the number of visible satellites is 5 or more, the processor 220 selects either a raw index calculation process or a calibrated index calculation process according to presence or absence of PDOP in operation S330.

For example, the processor 220 may select the raw index calculation process when an observation is lost due to an external factor during the calculation process of a positioning environment context index or when the PDOP is not calculated. For the first positioning environment context index calculation, the processor 220 may select the raw index calculation process regardless of presence or absence of PDOP. However, the processor 220 may select the calibrated index calculation process only when PDOP is present in both a previous epoch and a current epoch for the second and subsequent positioning environment context index calculations.

Each of positioning environment context index calculation processes including the raw index calculation process and the calibrated index calculation process is described in detail below. In the present disclosure below, a real number-type index may be an index or a positioning environment context index expressed in the form of a real number and may be a term that includes a real number-type raw index, I_{C/N0}, and a real number-type calibrated index, I. An integer-type index may be an index or a positioning environment context index expressed in the form of an integer and may be a term that includes an integer-type raw index and an integer-type calibrated index.

When the processor 220 selects the raw index calculation processor, the processor 220 may calculate a final positioning environment context index based on the C/N0 in operation S340a.

The processor 220 may obtain the real number-type raw index, I_{C/N0}, based on the C/N0 in operation S341a. The processor 220 may obtain the real number-type raw index corresponding to the C/N0 collected in the target observation environment in each epoch.

The real number-type raw index, I_{C/N0}, refers to the average distance between the target observation environment and the baseline statistics of more than 500,000 random observation values collected in advance in open outdoors, etc. That is, the real number-type raw index, I_{C/N0}, may be the average of Z-values with respect to the target observation environment for which the positioning environment context index is to be obtained. The real number-type raw index, I_{C/N0}, may be a measure of how close the C/N0 obtained from the target observation environment is, on average, to the open outdoors.

The real number-type raw index, I_{C/N0}, may be obtained through a model given by Equation 1. In the model of Equation 1, I_{C/N0} may be a real number-type raw index of the target observation environment and may be the average of values each obtained by subtracting a reference average, μ_{ref}, from a C/N0 of each of N satellites, which is acquired in an arbitrary epoch “t” in the target observation environment, and dividing a result of the subtraction by a standard deviation, σ_{ref}, with respect to the N satellites. The real number-type raw index, I_{C/N0}, may be expressed as a real number.

$${I}_{C / N 0} ( t ) = \frac{1}{N} {\sum }_{i = 1}^{N} ( C / N {0}_{i} ( t ) - {μ}_{ref} ) / {σ}_{ref} \qquad [ Equation 1 ]$$

Subsequently, the processor 220 may obtain an integer-type raw index by inputting the real number-type raw index, I_{C/N0}, into a classification model in operation S342a. Here, the classification model may designate, as a decision boundary, the intersection between normal distributions of adjacent indices in a normal distribution of the probability density of each index with respect to real number-type raw indices, which are obtained based on multiple C/N0s acquired with respect to various arbitrary observation environments for each index. The processor 220 may classify the real number-type raw index, I_{C/N0}, as an integer-type raw index based on the classification model.

Integer-type raw indices may respectively correspond to the indices defining the observation environments in operation S300. For example, the integer-type raw indices may be respectively represented as integers 1 to 5, according to FIG. 4.

FIG. 6 shows the normal probability density representation of more than 500,000 random observation values collected in advance from open areas, etc., with respect to the five observation environments defined in FIG. 4. The distribution of the sample mean, when collected in a sufficiently large quantity, may be assumed to be normal by the central limit theorem. Therefore, as shown in FIG. 6, real number-type raw indices with respect to arbitrary prior observation values may be represented as a normal distribution. In the normal distribution of real number-type raw indices with respect to the arbitrary prior observation values, a decision boundary may be defined based on the intersection of two adjacent normal distributions. In detail, the real number-type raw index value corresponding to the intersection of two adjacent normal distributions may be defined as the decision boundary.

For example, the decision boundary of the normal probability density of real number-type raw indices for the five observation environments in FIG. 6 and an index corresponding to the decision boundary may be defined as shown in Table 1. A minimum decision boundary corresponding to the index “1” may be defined as 0.00, and a maximum decision boundary corresponding to the index “1” may be defined as 1.24. The minimum decision boundary corresponding to the index “1” may be set to a point corresponding to the mean—3σ (where σ is a standard deviation), which is a boundary that ensures the reliability of the normal distribution. A minimum decision boundary corresponding to the index “2” may be defined as 1.24, and a maximum decision boundary corresponding to the index “2” may be defined as 1.93. A minimum decision boundary corresponding to the index “3” may be defined as 1.93, and a maximum decision boundary corresponding to the index “3” may be defined as 2.56. A minimum decision boundary corresponding to the index “4” may be defined as 2.56, and a maximum decision boundary corresponding to the index “4” may be defined as 3.50. A minimum decision boundary corresponding to the index “5” may be defined as 3.50, and a maximum decision boundary corresponding to the index “5” may be defined as 6.00. The maximum decision boundary corresponding to the index “5” may be set to a point corresponding to the mean+3σ. The values in FIG. 6 and Table 1 are just examples, and a decision boundary may vary with the content of observation values or a method of defining an index according to an observation environment.

TABLE 1

| Decision boundary | Index (output index) |
|---|---|
| [0.00 1.24] | 1 |
| [1.24 1.93] | 2 |
| [1.93 2.56] | 3 |
| [2.56 3.50] | 4 |
| [3.50 6.00] | 5 |

The processor 220 may classify the real number-type raw index, I_{C/N0}, based on the classification model including a decision boundary. In detail, the processor 220 may perform classification by checking a decision boundary within which the real number-type raw index, I_{C/N0}, falls and outputting an index (an output index) corresponding to the decision boundary as an integer-type raw index. For example, when the real number-type raw index, I_{C/N0}, calculated in a specific epoch is 1.1, the processor 220 may output 1 as the output index based on FIG. 6 and the classification model of Table 1.

The processor 220 may also perform maximum likelihood estimation (MLE) through a process of outputting an output index based on the classification model. In an example of a classification model derived based on the normal probability density of FIG. 6, it may be assumed that the processor 220 outputs 1 as an output index with respect to the real number-type raw index, I_{C/N0}, having a value of 1.1 in a specific epoch. Referring to the normal probability density of FIG. 6, it may be seen that the open outdoors of the index “1” has a higher probability density corresponding to the real number-type raw index, I_{C/N0}, than the semi-urban area of the index “2”, and this may mean that the processor 220 consequentially selects a category having a high likelihood. Likelihood refers to the probability that a given real number-type raw index belongs to a certain output index. Accordingly, when the processor 220 classifies a real number-type raw index based on a classification model, the processor 220 may also perform MLE.

The output index, i.e., the integer-type raw index, output as a result of operation 342a may be provided to the user device 100 as a positioning environment context index for the target observation environment in which a user wishes to perform positioning. A user or a developer may determine an observation environment in which the user device 100 is located by using the positioning environment context index obtained in this manner. In addition, the user or the developer may differently apply and develop a technique of improving positioning accuracy according to the determined observation environment, thereby designing a customized positioning accuracy improvement algorithm for each observation environment.

Referring back to FIG. 5, when the processor 220 selects the calibrated index calculation processor, the processor 220 may calculate a final positioning environment context index based on both the C/N0 and the PDOP in operation S340b.

First, the processor 220 may obtain the real number-type raw index, CINQ, based on the C/N0 in operation S341b. The method of obtaining the real number-type raw index, I_{C/N0}, may be the same as the method described in operation S341a, and thus, redundant descriptions thereof are omitted.

Subsequently, the processor 220 may obtain the real number-type calibrated index, I, based on the real number-type raw index, I_{C/N0}, and the PDOP in operation S342b.

The real number-type calibrated index, I, may be obtained by combining the real number-type raw index, I_{C/N0}, with the PDOP after assigning a weight to each of the real number-type raw index, I_{C/N0}, and the PDOP. The real number-type calibrated index, I, may be a measure that considers the influence of the PDOP on the target observation environment in addition to the real number-type raw index, I_{C/N0}.

The real number-type calibrated index, I, may be obtained through a model given by Equation 2. In Equation 2, W_{PDOP} is a weight related to the PDOP, W_{C/N0} is a weight related to the real number-type raw index, I_{C/N0}, and α is a real number and corresponds to a scale factor. The weight for each of ln PDOP and the real number-type raw index, I_{C/N0}, may change at each point in time, so the value of the calculated index may affect the scale. Therefore, a change in scale due to weighted combination may be prevented by multiplying an index obtained through weighted combination by the scale factor, α.

$$I = α ( {W}_{PDOP} ln PDOP + {W}_{C / N 0} {I}_{C / N 0} ) \qquad [ Equation 2 ]$$

A method for deriving a weighting factor is described with reference to FIG. 7.

First, to combine ln PDOP with the real number-type raw index, I_{C/N0}, the sigmoid function ((a) of FIG. 7), i.e. the variation of ln PDOP and the real number-type raw index, I_{C/N0}, may be used. The PDOP may have a large scale because the value of the PDOP increases rapidly according to an observation environment. Therefore, the PDOP may be scaled using a natural logarithm.

The sigmoid function of (a) of FIG. 7 may be given by Equation 3. The sigmoid function may be a function corresponding to [0,1] at [−∞, ∞].

$$f ( x ) = \frac{1}{1 + {e}^{- x}} \qquad [ Equation 3 ]$$

The weight related to the PDOP may be derived using, as input, Δ ln PDOP Indicating the variation of ln PDOP and ΔI_{C/N0} corresponding to the change of the real number-type raw index, I_{C/N0.} Weighting related to the PDOP may be performed by weighting using the sigmoid function. As a result, the weight, W_{PDOP}, applied to ln PDOP may be given by Equation 4. The weight, W_{C/N0} applied to I_{C/N0} may be given by Equation 5.

$${W}_{PDOP} = \frac{1}{1 + {e}^{- ( Δln PDOP - {ΔI}_{C / N 0} )}} \qquad [ Equation 4 ]$$

$${W}_{C / N 0} = 1 - {W}_{PDOP} \qquad [ Equation 5 ]$$

Referring to Equations 4 and 5, when the difference between Δ ln PDOP and ΔI_{C/N0} is greater than 0, W_{PDOP} may have a value greater than 0.5, and W_{C/N0} may have a value less than 0.5. When the difference between Δ ln PDOP and Δ I_{C/N0} is less than 0, W_{PDOP} may have a smaller value than W_{C/N0}. When the difference between Δ ln PDOP and Δ I_{C/N0} is 0, W_{PDOP} and W_{C/N0} may have the same value. Finally, the model for obtaining the real number-type calibrated index, I, that is calculated by combining ln PDOP considering the weight, W_{PDOP}, with I_{C/N0} considering the weight, W_{C/N0}, may be given by Equation 2 described above.

Referring back to FIG. 5, the processor 220 may select whether to adjust an index by selecting one of the different processes that derive an integer-type positioning environment context index based on the real number-type calibrated index, I, in operation S343b.

The processor 220 may determine whether to select a process of deriving a positioning environment context index through the classification model or a process of deriving a positioning environment context index through a calibrated classification model by comparing the variation, ΔPDOP, of the PDOP of the target observation environment with a certain threshold.

This is described in detail regarding to whether to adjust an index. First, the processor 220 may obtain an integer-type raw index determined for the target observation environment through the raw index calculation process in operation S340a that does not consider the PDOP. Subsequently, the processor 220 may set a threshold corresponding to each reference index, wherein the obtained integer-type raw index is using as the reference index in operation S343b. Here, the threshold may be defined as the upper limit of the 95% confidence interval of the PDOP data included in random prior observation values collected in observation environments corresponding to a certain reference index. However, the confidence interval may be changed from 95% to various values, such as 90% and 98%, according to a user's choice. A method of setting the threshold is described below with reference to FIG. 8.

Referring to FIG. 8, (a) to (d) of FIG. 8 illustrate PDOP values collected in advance in observation environments respectively corresponding to reference indices 1 to 4, respectively. In the graphs of (a) to (d) of FIG. 8, the vertical axis represents PDOP value, and the horizontal axis represents the unit of epoch, which may be seconds. Each slashed line expressed horizontally in each graph in FIG. 8 may be the upper limit of the 95% confidence interval of the PDOP data. Therefore, according to the definition of the threshold, in the case of the reference index “1” in (a) of FIG. 8, the threshold of the variation, ΔPDOP, of the PDOP is 0.0560; in the case of a reference index “2” in (b) of FIG. 8, the threshold of the variation, ΔPDOP, of the PDOP is 0.2979; in the case of a reference index “3” in (c) of FIG. 8, the threshold of the variation, ΔPDOP of the PDOP is 0.6960; and in the case of a reference index “4” in (d) of FIG. 8, the threshold of the variation, ΔPDOP, is 4.7950, which may be set as shown in Table 2.

TABLE 2

| | Threshold of variation, |
|---|---|
| Reference index | ΔPDOP, of PDOP |
| 1 | 0.0560 |
| 2 | 0.2979 |
| 3 | 0.6960 |
| 4 | 4.7950 |

The processor 220 may compare the variation, ΔPDOP of the PDOP with the threshold in operation S343b. In detail, the processor 220 may extract a threshold, which corresponds to a reference index identical to the integer-type raw index determined by the raw index calculation process, from among a plurality of thresholds set by the process described above and may compare the extracted threshold with the variation, ΔPDOP of the PDOP.

When the variation, A PDOP of the PDOP is less than or equal to the threshold as a result of the comparison, the processor 220 may obtain an integer-type raw index from the real number-type calibrated index by using the classification model, which is mentioned in operation S342a, in operation S344-1b. When the variation, ΔPDOP of the PDOP is less than or equal to the threshold, this may mean that the probability of an abnormal value occurring due to the PDOP with respect to each index is low. Therefore, even when the positioning environment context index is obtained through the classification model that does not consider PDOP according to the related art, the accuracy is not significantly affected. The process of obtaining the integer-type raw index through the classification model has been described in operation S342a, and thus, redundant descriptions thereof are omitted.

Otherwise, when the variation, ΔPDOP of the PDOP is greater than the threshold, the processor 220 may obtain an integer-type calibrated index from the real number-type calibrated index by using a new calibrated classification model in operation S344-2b. The calibrated classification model may have a calibrated decision boundary obtained taking into account the variation of the PDOP with respect to the decision boundary of the classification model described in operation S342a. The calibrated classification model is described in detail with reference to FIG. 9 below.

FIG. 9 shows a decision boundary, 1.93, which is the intersection of the normal distributions respectively corresponding to indices 2 and 3 in FIG. 6, as shown in Table 1. As described above, the classification model may convert a real number-type index value into an integer-type index value based on the decision boundary.

The calibrated classification model may convert a real number-type index value into an integer-type index value based on a calibrated decision boundary. The calibrated decision boundary may be determined by reflecting the variation, ΔPDOP, of the PDOP in an existing decision boundary in a current epoch when the variation, ΔPDOP of the PDOP exceeds the threshold. For example, the calibrated decision boundary may be determined by subtracting the variation, ΔPDOP of the PDOP from the existing decision boundary. As shown in Equation 6, a calibrated decision boundary, Bound₂, may be determined by subtracting the variation, ΔPDOP, of the PDOP from a decision boundary, Bound₁, which is applied to the raw index calculation. The processor 220 may generate the calibrated classification model based on the classification model. Additionally, the processor 220 may perform calibrated index calculation based on the calibrated classification model.

$$Bound 2 = Bound 1 - Δ PDOP \qquad [ Equation 6 ]$$

For example, a decision boundary of the classification model shown in Table 1 may be changed to a calibrated decision boundary of the calibrated classification model shown in Table 3 below. The processor 220 may output an integer-type calibrated index based on a real number-type calibrated index with respect to each epoch based on the calibrated classification model.

TABLE 3

| | Output index (integer-type |
|---|---|
| Calibrated decision boundary | calibrated index) |
| [0.00 1.24-ΔPDOP] | 1 |
| [1.24-ΔPDOP 1.93-ΔPDOP] | 2 |
| [1.93-ΔPDOP 2.56-ΔPDOP] | 3 |
| [2.56-ΔPDOP 3.50-ΔPDOP] | 4 |
| [3.50-ΔPDOP 6.00] | 5 |

In the case of observation through the user device 100, even when reception sensitivity is good and an average C/N0 is high, there may be cases where PDOP appears relatively high due to poor satellite placement in a current observation environment. In such cases, final positioning error may increase. Therefore, in order to consider the influence of positioning error that may occur when the variation, ΔPDOP, of the PDOP is greater than a certain threshold, an index raising task may be performed to establish the calibrated classification model by generating a calibrated decision boundary. This index raising may prevent an index from being underestimated.

A specific example is provided to describe a general method of calculating a positioning environment context index from an observation value for a target observation environment. In the example, a process may be performed based on the equations and tables described above.

For example, the case where the real number-type raw index, I_{C/N0}, in a certain epoch in the target observation environment is 0.8 is described. According to the raw index calculation process that does not consider the variation of the PDOP, an integer-type raw index is determined to be 1 according to the classification model having the decision boundaries in Table 1, and a final positioning environment context index may be output as 1.

However, according to the calibrated index calculation process that considers the variation, Δ PDOP, of the

PDOP, a different positioning environment context index may be derived according to the variation, ΔPDOP of the PDOP

For example, it may be assumed that the real number-type raw index, I_{C/N0}, in a specific epoch in the target observation environment is 0.8, as in the previous example, but the variation, ΔPDOP, of the PDOP is 0.06. In this case, the real number-type calibrated index, I, considering the PDOP may be 0.58. The processor 220 may selects the threshold, 0.0560, corresponding to the reference index “1” in Table 2 according to the integer-type raw index described above and may compare the selected threshold with the variation, ΔPDOP, of the PDOP. Here, because the variation, A PDOP, of the PDOP is greater than the threshold, the processor 220 may select the calibrated index calculation process using the calibrated classification model. The processor 220 may generate the calibrated classification model having the calibrated decision boundaries of Table 4, which results from correcting Table 3, in response to 0.06 corresponding to the variation, ΔPDOP of the PDOP, and may derive 1 as the integer-type calibrated index for the target observation environment, according to the calibrated classification model. That is, a final positioning environment context index may be output as 1 when the variation, ΔPDOP, of the PDOP is 0.06.

TABLE 4

| | Output index (integer-type |
|---|---|
| Calibrated decision boundary | calibrated index) |
| [0.00 1.18] | 1 |
| [1.18 1.87] | 2 |
| [1.87 2.50] | 3 |
| [2.50 3.44] | 4 |
| [3.44 6.00] | 5 |

As another example, the variation, ΔPDOP, of the PDOP may be assumed to be 0.5 not 0.06. In this case, the real number-type calibrated index, I, considering the PDOP may be 0.82. The processor 220 may select the threshold, 0.0560, corresponding to the reference index “1” in Table 2 according to the integer-type raw index described above and may compare the selected threshold with the variation, ΔPDOP, of the PDOP. Here, because the variation, ΔPDOP, of the PDOP is greater than the threshold, the processor 220 may select the calibrated index calculation process using the calibrated classification model. The processor 220 may generate the calibrated classification model having the calibrated decision boundaries of Table 5, which results from correcting Table 3, in response to 0.5 corresponding to the variation, ΔPDOP, of the PDOP, and may derive 2 as the integer-type calibrated index for the target observation environment, according to the calibrated classification model. That is, a final positioning environment context index may be output as 2 not 1 when the variation, ΔPDOP, of the PDOP is 0.5.

TABLE 5

| | Output index (integer-type |
|---|---|
| Calibrated decision boundary | calibrated index) |
| [0.00 0.74] | 1 |
| [0.74 1.43] | 2 |
| [1.43 2.06] | 3 |
| [2.06 3.00] | 4 |
| [3.00 6.00] | 5 |

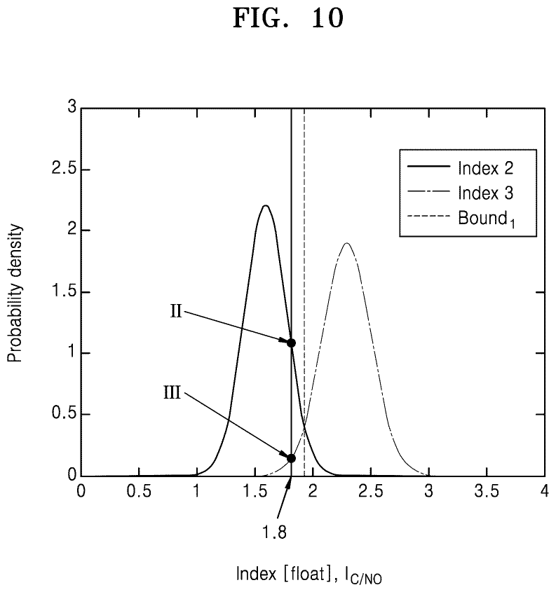

FIG. 10 is an explanatory diagram illustrating calculation of a likelihood ratio, according to an embodiment. For convenience of description, FIG. 10 selectively shows only normal probability densities respectively corresponding to indices 2 and 3 among the graphs of the normal probability densities corresponding to real number-type raw indices for the five observation environments in FIG. 4.

The positioning environment context index calculation device 200 (hereinafter, referred to as a device) may calculate additional detailed information regarding a classified observation environment. The additional detailed information may include a likelihood ratio. In other words, the device may output a positioning environment context index for an observation environment in each epoch and simultaneously calculate the likelihood ratio of an adjacent distribution and express the likelihood ratio as a percentage. The likelihood ratio may represent the degree of uncertainty of a finally calculated integer-type index (including an integer-type raw index or an integer-type calibrated index). Since the device provides a likelihood ratio in addition to an integer-type index, a positioning algorithm may be optimized based on a positioning environment context index and the uncertainty of the positioning environment context index.

The processor 220 may derive a likelihood ratio based on a real number-type index independently of the calculation of an integer-type index. In detail, the processor 220 may derive the likelihood ratio based on the intersection of a normal probability density with respect to various observation environments and a calculated real number-type index (e.g., the real number-type raw index, I_{C/N0}, or the real number-type calibrated index, I).

For example, referring to FIG. 10, it may be assumed that the calculated real number-type index is 1.8. With respect to the various observation environments, the intersection of the normal probability density of the index “2” and the calculated real number-type index may be derived as II, and the intersection of the normal probability density of the index “3” and the calculated real number-type index may be derived as III.

The likelihood ratio may be derived by expressing, as a percentage, a ratio of a probability density corresponding to an arbitrary real number-type index to a total probability density. Here, the probability density corresponding to an arbitrary real number-type index may be a probability density corresponding to the positioning environment context index of a target observation environment. The total probability density may be the sum of probability densities respectively corresponding to real number-type raw indices corresponding to arbitrary various observation environments by index, as illustrated in FIG. 6.

In detail, in a likelihood ratio model, as expressed in Equation 7, a likelihood ratio, Rₙ(x), of an index “n” may be derived by expressing, as a percentage, a ratio of a probability density, fₙ(x), of the index “n” corresponding to an arbitrary real number-type index “x” to a total probability density, f₁(x)+f₂(x)+f₃(x)+f₄(x)+f₅(x). The processor 220 may calculate the likelihood ratio of the positioning environment context index calculated for the target observation environment, based on the likelihood ratio model.

$$\begin{matrix}{R}_{n} ( x ) = \frac{{f}_{n} ( x )}{{f}_{1} ( x ) + {f}_{2} ( x ) + {f}_{3} ( x ) + {f}_{4} ( x ) + {f}_{5} ( x )} \times 100 , \\ n = 1 , … , 5\end{matrix} \qquad [ Equation 7 ]$$

The likelihood ratio, Rₙ(x), of the index Rₙ(x) may be greater than 0 and less than or equal to 100. The closer the likelihood ratio is to 100, the more likely the calculated positioning environment context index is to occur, and the closer the likelihood ratio is to 0, the less likely a corresponding index is to occur.

For example, it may be assumed that a real number-type index in FIG. 10 is 1.8, and the likelihood ratio, R₁(x), for the index “1” is calculated as 60. In this case, when an integer-type index for the target observation environment is derived as 1, the device may estimate that the uncertainty of the derived integer-type index is low and that the target observation environment is open outdoors.

As another example, it may be assumed that the integer-type index for the target observation environment is derived as 1 and that the likelihood ratio, R₁(x), for the index “1” is derived as 55 and the likelihood ratio, R₂(x) for the index “2” is derived as 45. The device may estimate that the uncertainty of the integer-type index derived through the likelihood ratio is high and that the observation environment is not completely open outdoors. For example, the device may estimate that a user device is moving and that the observation environment is changing from the open outdoors to the semi-urban area. In this manner, the likelihood ratio may provide uncertainty information regarding an integer-type index, which is not provided by the integer-type index.

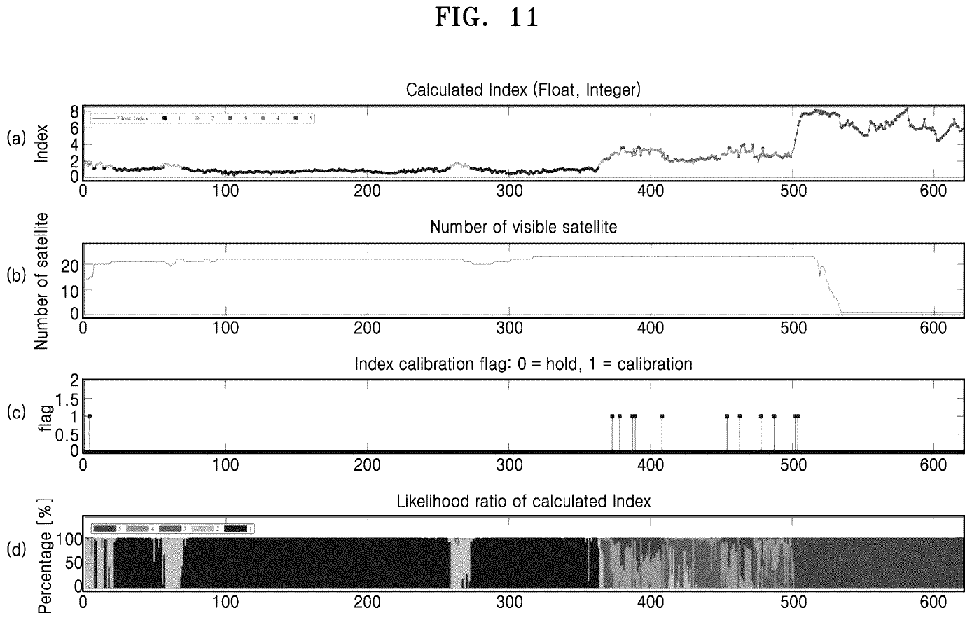

FIG. 11 is a graph showing results of performing, by a positioning environment context index calculation device, a method of calculating a positioning environment context index, according to an embodiment.

FIG. 11 shows data obtained in a walking environment in which the user device 100 moves from a playground, which is a type of open outdoors, to a multipurpose apartment complex over time (e.g., seconds). In each epoch, the device may calculate a real number-type index, an integer-type index, and a likelihood ratio. In addition, in each epoch, the device may perform the exception handling process (S320) according to a change in the number of visible satellites and may select whether to adjust an index according to the variation of the PDOP (S343b).

(a) of FIG. 11 is a graph showing a positioning environment context index output by a device over time in the walking environment, (b) of FIG. 11 is a graph showing the number of visible satellites changing over time in the walking environment, (c) of FIG. 11 is a graph showing an index adjustment epoch in which an integer-type calibrated index is derived in operation S344-2b because the variation of the PDOP exceeds a threshold over time in the walking environment, and (d) of FIG. 11 is a graph showing a likelihood ratio according to the positioning environment context index derived in (a) of FIG. 11.

Over the course of the walking environment from 0 seconds to about 600 seconds, the user device 100 may move from the playground to the multipurpose apartment complex. According to (a) of FIG. 11, it may be seen that as the user device 100 moves, a satellite arrangement changes due to buildings or obstacles, and thus, reception sensitivity decreases, causing the positioning environment context index to change from 1 to 5. Referring to (b) of FIG. 11, it may be seen that the number of visible satellites that may be checked as the user device 100 moves gradually decreases. Referring to (c) of FIG. 11, it may be seen that index adjustment according to the variation of the PDOP mainly occurs in the central urban area and the semi-indoor area, which respectively correspond to the positioning indices “3” and “4”. It may be seen that the device outputs the positioning environment context index “5” when the number of visible satellites is less than the threshold of 5 even when the possibilities of positioning indices “3,” “4,” and “5” coexist after 500 seconds, so it may be confirmed that the exception handling process is performed accurately.

According to an embodiment of the present invention, a method and device for calculating a GNSS positioning environment context index, which is based on a user device such as a smart phone, based on at least a C/N0, the number of visible satellites, and PDOP may be provided. The calculated positioning environment context index may ultimately represent the level of an observation environment that may affect positioning.

An embodiment of the present invention requires only a small amount of computation without complexity. In addition, since operation may be performed based on empirically accumulated data, a method and device according to an embodiment of the present invention may be implemented regardless of the type of computing device.

In addition, according to an embodiment of the present invention, a positioning performance improvement algorithm suitable for a target observation environment may be used by providing a likelihood ratio of an index together with the index.

Moreover, according to an embodiment of the present invention, categorical information provided together with coordinate information in numerical form may contribute to a user's more intuitive understanding of his or her location.

Furthermore, embodiments of the present invention may be compatible with various smartphone models that calculate a C/N0 and PDOP and may also be applied to geodetic receivers. Therefore, embodiments of the present invention may make an overall contribution to the field of GNSS positioning.

According to an embodiment, a highly reliable positioning environment context index may be calculated based on an observation value of a smartphone, and observation environments may be accurately classified, thereby helping to design an algorithm improving positioning accuracy according to an observation environment. Ultimately, high-quality location information may be provided to a user.

Although the present invention has been described with reference to the embodiments shown in the drawings, these are merely examples, and those skilled in the art will understand that various modifications can be made in the embodiments and equivalent other embodiments can be inferred therefrom. Therefore, the technical scope of the present invention should be defined by the spirit of the appended claims.

What is claimed is:

1. A method of calculating a positioning environment context index for classifying an observation environment, the method comprising:
classifying and defining various observation environments by index;
receiving observation values including at least the number of visible satellites, position dilution of precision (PDOP), and a carrier-to-noise density ratio (C/N0) with respect to a target observation environment;
performing an exception handling process based on the number of visible satellites;
selecting a process among a raw index calculation process and a calibrated index calculation process based on presence or absence of the PDOP; and
deriving the index corresponding to the target observation environment based on the C/N0 or the C/N0 and PDOP via the process which is selected,
wherein the method is performed by a processor.

2. The method of claim 1, wherein
the raw index calculation process includes
obtaining a real number-type raw index based on the C/N0, inputting the real number-type raw index into a classification model, and deriving an integer-type raw index as the index.

3. The method of claim 2, wherein
the calibrated index calculation process includes
obtaining the real number-type raw index based on the C/N0, obtaining a real number-type calibrated index considering the real number-type raw index and the PDOP, and deriving an integer-type calibrated index from the real number-type calibrated index as the index, or deriving an integer-type raw index from the real number-type calibrated index as the index.

4. The method of claim 1, wherein
the various observation environments are classified into and defined as open outdoors, a semi-urban area, a central urban area, a semi-indoor area, and an indoor area.

5. The method of claim 1, wherein
the exception handling process includes
determining whether the number of visible satellites meets a positioning requirement.

6. The method of claim 1, wherein
the selecting process includes:
selecting the raw index calculation process for a first positioning environment context index calculation; and
selecting the calibrated index calculation process when the PDOP is present in both a previous epoch and a current epoch for second and subsequent positioning environment context index calculations.

7. The method of claim 2, wherein
the processor is configured to derive the real number-type raw index, I_{C/N0}, based on a model,
$${I}_{C / N 0} ( t ) = \frac{1}{N} {\sum }_{i = 1}^{N} ( C / N {0}_{i} ( t ) - {μ}_{ref} ) / {σ}_{ref} ,$$
which is an average of values each obtained by subtracting a reference average, μ_{ref}, from a C/N0 of each of N satellites, which is acquired in an arbitrary epoch “t” in the target observation environment, and dividing a result of the subtraction by a standard deviation, σ_{ref}, with respect to the N satellites.

8. The method of claim 2, wherein
the classification model designates, as a decision boundary, an intersection between normal distributions respectively for adjacent indices in a normal distribution of a probability density for each of real number-type raw indices obtained based on multiple C/N0s acquired with respect to various arbitrary observation environments for each index, and
the processor is configured to derive the integer-type raw index from the real number-type raw index based on the classification model.

9. The method of claim 3, wherein
the processor is configured to obtain the real number-type calibrated index through a model,
$$I = α ( {W}_{PDOP} ln PDOP + {W}_{C / N 0} {I}_{C / N 0} ) ,$$
where α is a scale factor, W_{PDOP} is a weight for the PDOP, and W_{C/N0} is a weight for the real number-type raw index.

10. The method of claim 3, wherein
the calibrated index calculation process includes,
when a variation of the PDOP exceeds a threshold, obtaining the integer-type calibrated index by inputting the real number-type calibrated index obtained by the processor into a calibrated classification model, or
when the variation of the PDOP is less than or equal to the threshold, obtaining the integer-type raw index by inputting the real number-type calibrated index obtained by the processor into the classification model.

11. The method of claim 10, wherein
the calibrated classification model includes a calibrated decision boundary considering the variation of the PDOP with respect to a decision boundary of the classification model, and
the processor is configured to input the real number-type calibrated index into the calibrated classification model and obtain the integer-type calibrated index according to the calibrated decision boundary.

12. The method of claim 1, further comprising
calculating a likelihood ratio representing uncertainty of the positioning environment context index.

13. The method of claim 12, wherein
the likelihood ratio is obtained by expressing, as a percentage, a ratio of a probability density corresponding to a real number-type raw index or a real number-type calibrated index, each corresponding to a positioning environment context index of the target observation environment, to a sum of probability densities of real number-type raw indices corresponding to various arbitrary observation environments for each index.

14. The method of claim 3, wherein
the processor is configured to
derive the real number-type raw index, I_{C/N0}, based on a model,
$${I}_{C / N 0} ( t ) = \frac{1}{N} {\sum }_{i = 1}^{N} ( C / N {0}_{i} ( t ) - {μ}_{ref} ) / {σ}_{ref} ,$$
which is an average of values each obtained by subtracting a reference average, μ_{ref}, from a C/N0 of each of N satellites, which is acquired in an arbitrary epoch “t” in the target observation environment, and dividing a result of the subtraction by a standard deviation, σ_{ref}, with respect to the N satellites.

15. The method of claim 3, wherein
the classification model designates, as a decision boundary, an intersection between normal distributions respectively for adjacent indices in a normal distribution of a probability density for each of real number-type raw indices obtained based on multiple C/N0s acquired with respect to various arbitrary observation environments for each index, and
the processor is configured to derive the integer-type raw index from the real number-type raw index based on the classification model.
